(19) United States
(12) Patent Application Publication
(10) Pub. No.: US 2006/0148941 A1
(43) Pub. Date: Jul. 6, 2006

(54) Monosubstituted 6-aminouracils for the stabilization of halogenated polymers

(76) Inventors: Wofgang Wehner, Zwingenberg (DE); Hans-Helmut Friedrich, Lautertal-Gadernheim (GB)

Correspondence Address: Michael P Dilworth;Crompton Corporation, 199 Benson Road, Middlebury, CT, 06749, US

(21) Appl. No.: 10/537,331

(22) PCT Filed: Nov. 19, 2003
(86) PCT No.: PCT/EP03/12921

§ 371 Date: Jun. 2, 2005

(30) Foreign Application Priority Data
Dec. 2, 2002 (EP) 02026875.1

(51) Int. Cl. C08K 5/34

(52) U.S. Cl. 524/100

(57) ABSTRACT

Compositions comprising a chlorinated polymer and at least one compound of formula (I) where R¹ or R²=linear or branched C₃-C₂₂ alkyl, unsubstituted or substituted with C₁-C₄ alkyl/alkoxy and/or hydroxy phenyl, unsubstituted or substituted by C₁-C₄ alkyl/alkoxy and/or hydroxy phenyl C₁-C₄ alkyl, linear or branched C₃-C₁₈ alkenyl, C₃-C₈— cycloalkyl, C₃-C₁₀ alkyl or C₃-C₁₀ hydroxyalkyl or acetoxy/benzoyloxy C₂-C₁₀ alkyl interrupted by at least one oxygen atom, as stabilisers for halogenated polymers.

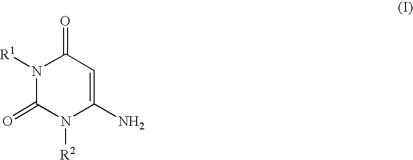

The invention relates to compositions composed of chlorinated (i.e., chlorine-containing) polymers and aminouracils of the formula I depicted below and to the use of these aminouracils for stabilizing these polymers, especially PVC.

PVC can be stabilized by a range of additives. Compounds of lead, of barium and of cadmium are particularly suitable for this purpose but are nowadays controversial on ecological grounds or because of their heavy metal content (cf. “Plastics Additives Handbook”, H. Zweifel, Carl Hanser Verlag, 5th ed., 2001, pages 427-483, and “Kunststoff Handbuch PVC”, volume 2/1, W. Becker/D. Braun, Carl Hanser Verlag, 2nd ed., 1985, pages 531-538; and also Kirk-Othmer: “Encyclopedia of Chemical Technology”, 4^{th} ed., 1994, Vol. 12, Heat Stabilizers, pp. 1071-1091). The search therefore continues for effective stabilizers and stabilizer combinations which are free from lead, barium and cadmium.

The stabilizer action of 1,3-disubstituted aminouracils has already been described in U.S. Pat. No. 3,436,362, U.S. Pat. No. 4,656,209, U.S. Pat. No. 4,352,903 and EP-A-0 967 245, EP-A-0 967 209, EP-A-0 967 208 and EP-A-0 044 968.

It has now surprisingly been found that monosubstituted 6-aminouracils of the general formula I 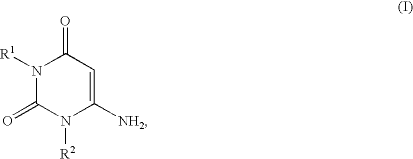
where R¹ or R² is linear or branched C₃-C₂₂-alkyl-, unsubstituted or C₁-C₄-alkyl/alkoxy- and/or hydroxyl-substituted phenyl, unsubstituted or C₁-C₄-alkyl/alkoxy- and/or hydroxyl-substituted phenyl-C₁-C₄-alkyl, linear or branched C₃-C₁₈-alkenyl, C₃-C₈-cycloalkyl, C₂-C₁₀-alkyl interrupted by at least 1 oxygen atom, or C₃-C₁₀-hydroxyalkyl or acetoxy/benzoyloxy-C₂-C₁₀-alkyl and R¹ or R² is hydrogen, are particularly suitable for stabilizing chlorinated polymers such as PVC, for example. Provided herewith is an alternative 6-aminouracil-based system.

For compounds of the formula I it is the case that: C₃-C₂₂-alkyl embraces n-propyl, isopropyl, n-butyl, isobutyl, sec-butyl or t-butyl, pentyl, hexyl, heptyl, octyl, 2-ethylhexyl, isooctyl, decyl, nonyl, undecyl, dodecyl, hexadecyl, octadecyl, eicosyl and docosyl. Preference is given to n-propyl, n-butyl, hexyl and octyl. Very particular preference is given to these radicals as R¹ substituents.

C₃-C₁₈-Alkenyl is, for example, allyl, methallyl, 1-butenyl, 2-butenyl, 3-butenyl, isobutenyl, 1-pentenyl, 2-pentenyl, 3-pentenyl, 4-pentenyl, 1-hexenyl, 2-hexenyl, 3-hexenyl, 4-hexenyl, 5-hexenyl and also their isomers, and oleyl. Preference is given to allyl, methallyl and butenyl. Very particular preference is given to these radicals as R¹ substituents.

C₃-C₈-Cycloalkyl is, for example, cyclopropyl, cyclobutyl, cyclopentyl, cyclohexyl, cycloheptyl or cyclooctyl, preference being given to cyclopentyl, cyclohexyl or cycloheptyl; the unsubstituted or C₁-C₄-alkyl/alkoxy- and/or hydroxyl-substituted phenyl radicals and the unsubstituted or C₁-C₄-alkyl/alkoxy- and/or hydroxyl-substituted phenyl-C₁C₄-alkyl are, for example, benzyl, 1- or 2-phenylethyl, 3-phenylpropyl, α,α-dimethylbenzyl or 2-phenylisopropyl, preferably 2-phenethyl and benzyl. Substitution on the phenyl ring can be by three, two or, in particular, one substituent, the substituents being able to be hydroxyl, methyl, ethyl, propyl, butyl, methoxy, ethoxy, propoxy and butoxy.

Preference is given to tolyl, xylyl and mesityl. Very particular preference is given to these radicals as R¹ substituents.

Where the alkyl radicals are interrupted by oxygen they necessarily contain at least two carbon atoms.

Hydroxyalkyl is: 2-hydroxypropyl, 3-hydroxypropyl, 2-hydroxybutyl, 3-hydroxybutyl and 4-hydroxybutyl. Preference is given to 3-hydroxypropyl and 4-

Hydroxyalkyl. Acylated hydroxyalkyl is acetoxy- and benzoyloxy-C₂-C₁₀-alkyl. Preference is given to acetoxyethyl and -propyl. Very particular preference is given to these radicals as R¹ substituents.

Examples of —O— interrupted C₃-C₁₀-alkyl radicals are branched or straight-chain radicals such as, for example, methoxymethyl, methoxyethyl, methoxypropyl, methoxybutyl, methoxyhexyl, methoxyoctyl, ethoxymethyl, ethoxyethyl, ethoxypropyl, ethoxybutyl, ethoxyhexyl, ethoxyoctyl, n-propoxymethyl, n-propoxyethyl, n-propoxybutyl, n-propoxyhexyl, isopropoxymethyl, isopropoxyethyl, isopropoxybutyl, isopropoxyhexyl, n-butoxymethyl, n-butoxylethyl, n-butoxybutyl, n-butoxyhexyl or t-butoxymethyl etc. Preference is given, for example, to methoxy- or ethoxypropyl and also methoxyethyl and ethoxyethyl. Very particular preference is given to these radicals as R¹ substituents.

The alkyl chain may also be interrupted by more than one —O—. Examples thereof are —CH₂—O—CH₂—CH₂—O—CH₃, —CH₂—O—CH₂—CH₂—CH₂—O—CH₃, —CH₂—O—CH₂—CH₂—CH₂—CH₂—O—CH₃, —CH₂—CH₂—O—CH₂—CH₂—O—CH₂—CH₃, —CH₂—CH₂—O—CH₂—CH₂—O—CH₂—CH₂—O—CH₂—CH₃ etc.

Here as well, structural isomers are possible, which if desired may additionally carry OH groups.

Examples thereof are —CH₂—O—CH₂—CH₂—OH, —CH₂—O—CH₂—CH₂—CH₂—OH, —CH₂—O—CH₂—CH₂—CH₂—CH₂—OH, —CH₂—CH₂—O—CH₂—CH₂—O—CH₂—CH₂—OH, —CH₂—CH₂—O—CH₂—CH₂—O—CH₂—CH₂—O—CH₂—CH₂—OH etc., and also radicals which carry the OH group(s) within the chain, such as —H₂—O—CH₂—CH(OH)—CH₂—CH₃, for example.

Preference is also given to compounds of the formula I in which R¹ or R² is phenyl, benzyl, 2-phenethyl, allyl, or C₃-C₁₀-alkyl interrupted by 1 to 3 oxygen atoms. Very particular preference is given to these radicals as R¹ substituents.

Particularly preferred compounds of the formula I are those where R¹ or R² is propyl or butyl or cyclohexyl, or is oxygen-interrupted C₄-C₆-alkyl or allyl. Very particular preference is given to these radicals as R¹ substituents.

The compounds of the formula I are to be used advantageously at from 0.01% to 10% by weight, preferably at from 0.05% to 5% by weight, in particular at from 0.1% to 3% by weight, in order to obtain stabilization in the chlorinated polymer.

Further provided in accordance with the invention are new compounds of the formula (II)

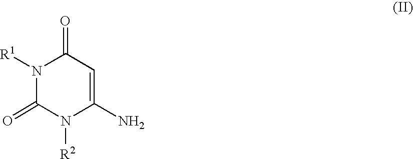

In these compounds, R¹ or R² is C₃-C₈-cycloalkyl, C₄-C₁₀-hydroxyalkyl or acetoxy/benzoyloxy-C₂-C₁₀-alkyl and R¹ or R² is hydrogen.

With regard to the definition of the radicals R¹ or R², the further elucidations apply as above in connection with compounds of the formula (I).

Particular preference is given to the monosubstituted uracils of the formulae (I) and (II) specified explicitly according to table 1, it being possible for these compounds to be used alone or else in a mixture, and also with other additives.

It is also possible to employ combinations of compounds of the general formula I with other, customary additives and stabilizers, for example with polyols and disaccharide alcohols and/or perchlorate compounds and/or glycidyl compounds and/or zeolite compounds and/or layered lattice compounds (hydrotalcites) and also β-diketones or β-keto esters and other N-containing stabilizers as described in EP-A-0 967 245, EP-A-0 967 209, EP-A-0 967 208, EP-A-0 736 569, EP-A-0 962 491, EP-A-390 739, WO-A-02/072684, EP-A-1 044 968, U.S. Pat. No. 4,290,940, U.S. Pat. No. 4,369,277, WO-A-02/02685 and WO-A-02/072684. Examples of such additional components are listed and elucidated below.

Polyols and Disaccharide Alcohols

Examples of suitable compounds of this type are: pentaerythritol, dipentaerythritol, tripentaerythritol, trimethylolethane, bistrimethylolpropane, inositol (cyclitols), polyvinyl alcohol, bis-trimethylolethane, trimethylolpropane, sorbitol (hexitols), maltitol, isomaltitol, cellobiitol, lactitol, lycasine, mannitol, lactose, leucrose, tris(hydroxyethyl) isocyanurate, tris(hydroxypropyl) isocyanurate, palatinitol, tetramethylolcyclohexanol, tetramethylolcyclopentanol, tetramethylolcyclopyranol, xylitol, arabinitol (pentitols), tetritols, glycerol, diglycerol, polyglycerol, thiodiglycerol or 1-0-α-D-glycopyranosyl-D-mannitol dihydrate. Of these, preference is given to the disaccharide alcohols.

It is also possible to use polyol syrups, such as sorbitol, mannitol and maltitol syrup.

The polyols can be employed in an amount of, for example, from 0.01 to 20, advantageously from 0.1 to 20 and, in particular, from 0.1 to 10 parts by weight per 100 parts by weight of PVC.

Perchlorate Salts

Examples are those of the formula M(CIO₄)ₙ, in which M is H, NH₄, Li, Na, K, Mg, Ca, Sr, Ba, Zn, Al, La or Ce. Depending on the valency of M, the index n is 1, 2 or 3. The perchlorate salts can be present as solutions or can have been complexed with alcohols (polyols, cyclodextrins) or ether alcohols or ester alcohols. The perchlorates may also be in the form of onium compounds with organic radicals on the cation-forming heteroatom nitrogen, phosphorus or sulphur; for instance, it is possible to use organic ammonium, sulfonium or phosphonium perchlorates of any desired consistency and constitution, as described in WO 03/082974, hereby incorporated in its entirety by reference, including its definition of the onium perchlorates on page 3 to 8, and so considered part of the disclosure content of the present text.

The ester alcohols also include the polyol partial esters. In the case of polyhydric alcohols or polyols, their dimers, trimers, oligomers and polymers are also suitable, such as di-, tri-, tetra- and polyglycols and also di-, tri- and tetrapentaerythritol or polyvinyl alcohol in various degrees of polymerization. Other suitable solvents are phosphate esters and also cyclic and acyclic carbonates.

In this context, the perchlorate salts can be employed in various common forms of presentation; for example, as a salt or solution in water or an organic solvent as such, or adsorbed on a support material such as PVC, Ca silicate, zeolites or hydrotalcites, or bound by chemical reaction into a hydrotalcite or into another layered lattice compound. As polyol partial ethers, preference is given to glycerol monoethers and glycerol monothioethers.

What is critical is not the selection of the cation but rather the presence of the perchlorate as such. The cation only affects the possible form of presentation, as a liquid or solid stabilizer component, and affects certain Theological properties of the polymer thus stabilized.

Further embodiments are described in EP-A-0 394 547, EP-A-0 457 471 and WO-A-94/24200.

The perchlorates can be employed in an amount of, for example, from 0.001 to 5, advantageously from 0.01 to 3, and, with particular preference, from 0.01 to 2 parts by weight per 100 parts by weight of PVC.

Glycidyl Compounds

These contain the glycidyl group 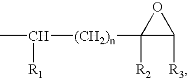
attached directly to carbon, oxygen, nitrogen or sulfur atoms, and in such compounds either R₁ and R₃ are both hydrogen and R₂ is hydrogen or methyl and n is 0 or R₁ and R₃ together are —CH₂—CH₂— or —CH₂—CH₂—CH₂— and in that case R₂ is hydrogen and n is 0 or 1. They are therefore glycidyl ethers, thioethers, esters or thioesters, and N-glycidyl and C-glycidyl compounds.

I) Glycidyl esters and β-methylglycidyl esters obtainable by reacting a compound having at least one carboxyl group in the molecule with epichlorohydrin or glyceroldichlorohydrin or β-methylepichlorohydrin. The reaction takes place advantageously in the presence of bases.

As compounds having at least one carboxyl group in the molecule it is possible to use aliphatic carboxylic acids. Examples of these carboxylic acids are glutaric, adipic, pimelic, suberic, azelaic and sebacic acid or dimerized or trimerized linoleic acid, acrylic and methacrylic acid, caproic, caprylic, lauric, myristic, palmitic, stearic and pelargonic acid, and also the acids mentioned in connection with the organozinc compounds.

However, it is also possible to employ cycloaliphatic carboxylic acids, such as, for example, cyclohexanecarboxylic, tetrahydrophthalic, 4-methyltetrahydrophthalic, hexahydrophthalic or 4-methylhexahydrophthalic acid.

Aromatic carboxylic acids can also be used, examples being benzoic, phthalic, isophthalic, trimellitic and pyromellitic acid.

It is likewise possible to make use of carboxyl-terminated adducts of, for example, trimellitic acid with polyols, such as glycerol or 2,2-bis(4-hydroxy-cyclohexyl)propane.

Other epoxide compounds which can be used in the context of this invention are given in EP-A-0 506 617.

II) Glycidyl ethers or β-methylglycidyl ethers obtainable by reacting a compound having at least one free alcoholic hydroxyl group and/or phenolic hydroxyl group with an appropriately substituted epichlorohydrin under alkaline conditions or in the presence of an acidic catalyst with subsequent alkali treatment.

Ethers of this type are derived, for example, from acyclic alcohols, such as ethylene glycol, diethylene glycol and higher poly(oxyethylene) glycols, propane-1,2-diol, or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, bistrimethylolpropane, pentaerythritol, sorbitol, and from polyepichlorohydrins, butanol, amyl alcohol, pentanol, and from monofunctional alcohols such as isooctanol, 2-ethylhexanol, isodecanol and also C₇-C₉-alkanol and C₉-C₁₁-alkanol mixtures.

They are also derived, however, for example, from cycloaliphatic alcohols, such as 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or they possess aromatic nuclei, such as N,N-bis(2-hydroxyethyl)aniline or p,p′-bis(2-hydroxyethylamino)diphenylmethane.

The epoxide compounds can also be derived from mononuclear phenols, such as, for example, from phenol, resorcinol or hydroquinone; or, they are based on polynuclear phenols, such as, for example, on bis(4-hydroxyphenyl)methane, 2,2-bis(4-hydroxyphenyl)propane, 2,2-bis(3,5-dibromo-4-hydroxyphenyl)-propane, 4,4′-dihydroxydiphenyl sulfone or on condensates of phenols with formaldehyde obtained under acidic conditions, such as phenol novolaks.

Examples of further possible terminal epoxides are: glycidyl 1-naphthyl ether, glycidyl 2-phenylphenyl ether, 2-biphenylyl glycidyl ether, N-(2,3-epoxypropyl)phthalimide and 2,3-epoxypropyl 4-methoxyphenyl ether.

III) N-Glycidyl compounds obtainable by dehydrochlorination of the reaction products of epichlorohydrin with amines containing at least one amino hydrogen atom. These amines are, for example, aniline, N-methylaniline, toluidine, n-butylamine, bis(4-aminophenyl)methane, m-xylylenediamine or bis-(4-methylaminophenyl)methane, and also N,N,O-triglycidyl-m-aminophenol or N,N,O-triglycidyl-p-aminophenol.

However, the N-glycidyl compounds also include N,N′-di-, N,N′,N″-tri- and N,N′,N″,N′″-tetraglycidyl derivatives of cycloalkyleneureas, such as ethyleneurea or 1,3-propyleneurea and N,N′-diglycidyl derivatives of hydantoins, such as of 5,5-dimethylhydantoin or glycoluril and triglycidyl isocyanurate.

IV) S-Glycidyl compounds such as di-S-glycidyl derivatives derived from dithiols, such as ethane-1,2-dithiol or bis(4-mercaptomethylphenyl) ether, for example.

V) Epoxy compounds having a radical of the above formula in which R₁ and R₃ together are —CH₂—CH₂— and n is 0 are bis(2,3-epoxycyclopentyl) ether, 2,3-epoxycyclopentylglycidyl ether or 1,2-bis(2,3-epoxycyclopentyloxy) ethane. An epoxy resin having a radical of the above formula in which R₁ and R₃ together are —CH₂—CH₂— and n is 1 is, for example, (3′,4′-epoxy-6′-methylcyclohexyl)methyl 3,4-epoxy-6-methylcyclohexanecarboxylate.

Examples of suitable terminal epoxides are:

a) liquid bisphenol A diglycidyl ethers, such as Araldit®GY 240, Araldit®GY 250, Araldit®GY 260, Araldit®GY 266 or GY 280, Araldit®GY 2600, Araldit®)MY 790;

b) solid bisphenol A diglycidyl ethers, such as Araldit®GT 6071, Araldit®GT 7071, Araldit®GT 7072, Araldit®GT 6063, Araldit®)GT 7203, Araldit®GT 6064, Araldit®GT 7304, Araldit®GT 7004, Araldit®GT 6084,Araldit®GT 1999, Araldit®GT 7077, Araldit®GT 6097, Araldit®GT 7097, Araldit®GT 7008, Araldit®GT 6099, Araldit®GT 6608, Araldit®GT 6609, Araldit®GT 6610;

c) liquid bisphenol F diglycidyl ethers, such as Araldit®GY 281, Araldit®PY 302, Araldit®PY 306;

d) solid polyglycidyl ethers of tetraphenylethane, such as CG Epoxy Resin®0163;

e) solid and liquid polyglycidyl ethers of phenol-formaldehyde novolak, such as EPN 1138, EPN 1139, GY 1180, PY 307;

f) solid and liquid polyglycidyl ethers of o-cresol-formaldehyde novolak, such as ECN 1235, ECN 1273, ECN 1280, ECN 1299;

g) liquid glycidyl ethers of alcohols, such as Shell® Glycidyl ether 162, Araldit®DY 0390, Araldit®DY 0391;

h) liquid or solid glycidyl ethers of carboxylic acids, Shell®Cardura E and also terephthalic acid ester, isophthalic acid ester and trimellitic acid ester, such as Araldit®PY 284 and Araldit® PT910;

i) solid heterocyclic epoxy resins (triglycidyl isocyanurate), such as Araldit® PT 810 and U-glycidylphthalimade;

j) liquid cycloaliphatic epoxy resins such as Araldit®CY 179;

k) liquid N,N,O-triglycidyl ethers of p-aminophenol, such as Araldit©MY 0510;

l) tetraglycidyl-4,4′-methylenebenzamine or N,N,N′,N′-tetraglycidyldiaminophenylmethane, such as Araldit®)MY 720, Araldit®MY 721.

m) polymeric or copolymeric glycidyl esters of acrylic and methacrylic acid.

Preference is given to the use of epoxy compounds having two functional groups. In principle, however, it is also possible to employ epoxy compounds having one, three or more functional groups.

Use is made predominantly of epoxy compounds, especially diglycidyl compounds, having aromatic groups.

If desired, it is also possible to employ a mixture of different epoxy compounds. Particular preference is given as terminal epoxy compounds to diglycidyl ethers based on bisphenols, such as on 2,2-bis(4-hydroxyphenyl)propane (bisphenol A), bis(4-hydroxyphenyl)methane or mixtures of bis(ortho/para-hydroxyphenyl)methane (bisphenol F), for example.

The terminal epoxy compounds can be employed in an amount of preferably at least 0.1 part, for example from 0.1 to 50, advantageously from 1 to 30 and in particular, from 1 to 25 parts by weight, per 100 parts by weight of PVC.

Hydrotalcites and Alkali(ne earth) Metal Aluminosilicates (Zeolites)

The chemical composition of these compounds is known to the person skilled 20 in the art, for example, from patents DE-A-3 843 581, U.S. Pat. No. 4,000,100, EP-A-0 062 813 and WO-A-93/20135.

Compounds from the series of the hydrotalcites can be described by the following general formula
M²⁺₁₋ₓM³⁺ₓ(OH)₂ (A^{b-})_{x/b}.d H₂O
where

M²⁺=one or more metals from the group Mg, Ca, Sr, Zn and Sn,

M³⁺=Al, or B,

Aⁿ is an anion having the valency n,
b is a number from 1-2,
   0<x<0.5,

m is a number from 0-20.

Preferably

Aⁿ =OH⁻, ClO₄⁻, HCO₃⁻, CH₃COO⁻, C₆H₅COO⁻, CO₃²⁻, (CHOHCOO)₂²⁻, (CH₂COO)₂²⁻, CH₃CHOHCOO⁻, HPO₃⁻ or HPO₄²⁻;

Examples of Hydrotalcites Are

Al ₂O₃.6MgO.CO₂.12H₂O (i), Mg_{4,5}Al₂(OH)₁₃.CO₃.3.5H₂O (ii), 4MgO.Al₂O₃.CO₂.9H₂O (iii), 4MgO.Al₂O₃.CO₂.6H₂O, ZnO.3MgO.Al₂O₃.CO₂.8-9H₂O and ZnO.3MgO.Al₂O₃.CO₂.5-6H₂O.

Very particular preference is given to types i, ii and iii.

Zeolites (Alkali Metal and Alkaline Earth Metal Aluminosilicates)

These can be described by the following general formula

M_{x/n}[(AlO₂)ₓ(SiO₂)_{y}].wH₂O

in which n is the charge of the cation M;

M is an element from the first or second main group, such as Li, Na, K, Mg, Ca, Sr or Ba;

y: x is a number from 0.8 to 15, preferably from 0.8 to 1.2; and

w is a number from 0 to 300, preferably from 0.5 to 30.

Examples of zeolites are sodium aluminosilicates of the formulae Na₁₂Al₁₂Si₁₂O₄₈.27H₂O[zeolite A], Na₆Al₆Si₆O₂₄.2NaX.7.5H₂O, X=OH, halogen, ClO₄[sodalite]; Na₆Al₆Si₃₀O₇₂. 24H₂O; Na₈Al₈Si₄₀O₉₆. 24H₂); Na₁₆Al₁₆Si₂₄O₈₀.16H₂O; Na₁₆Al₁₆Si₃₂O₉₆.16H₂O; Na₅₆Al₅₆Si₁₃₆O₃₈₄.250H₂O [zeolite Y], Na₈₆Al₈₆Si₁₀₆O₃₈₄.264H₂O[zeolite X];

or the zeolites preparable by complete or partial replacement of the Na atoms by Li, K, Mg, Ca, Sr or Zn atoms, such as (Na,K)₁₀Al₁₀Si₂₂O₆₄.20H₂O; Ca_{4,5}Na₃[(AlO₂)₁₂(SiO₂).30H₂O; K₉Na₃[(AlO₂)₁₂(SiO₂)₁₂].27H₂O, Preferred zeolites are those of the formulae Na₁₂Al₁₂Si₁₂O₄₈.27H₂O[zeolite A], Na₆Al₆Si₆O₂₄.2NaX.7.5H₂O, X═OH, Cl, ClO₄, ½CO₃[sodalite]Na₆Al₆Si₃₀O₇₂.24H₂O, Na₈Al₈Si₄₀O₉₆.24H₂O, Na₁₆Al₁₆Si₂₄O₈₀.16H₂O, Na₁₆Al₁₆Si₃₂O₉₆.16H₂O, Na₅₆Al₅₆Si₁₃₆O₃₈₄.250H₂O[zeolite Y], Na₈₆Al₈₆Si₁₀₆O₃₈₄.264H₂O[zeolite X]and those X and Y zeolites having an Al/Si ratio of about 1:1,

or the zeolites preparable by complete or partial replacement of the Na atoms by Li, K, Mg, Ca, Sr, Ba or Zn atoms, such as
(Na,K)₁₀Al₁₀Si₂₂O₆₄.20H₂O .
Ca_{4,5}Na₃[(AlO₂)₁₂(SiO₂)₁₂].30H₂O
K₉Na₃[(AlO₂)₁₂(SiO₂)₁₂].27H₂O

The zeolites indicated can also be lower in water content, or anhydrous.

Further suitable zeolites are:

Na₂O.Al₂O₃.(2 to 5) SiO₂.(3.5 to 10) H₂O [zeolite P]

Na₂O.Al₂O₃.2SiO₂.(3.5-10)H₂O (zeolite MAP)

or the zeolites preparable by complete or partial replacement of the Na atoms by Li, K or H atoms, such as

(Li,Na,K,H)₁₀Al₁₀Si₂₂O₆₄.20H₂O.

K₉Na₃[(AlO₂)₁₂(SiO₂)₁₂].27H₂O

K₄Al₄Si₄O₁₆.6H₂O [zeolite K-F]

Na₈Al₈Si₄₀O₉₆.24H₂O [zeolite D], as described in Barrer et al., J. Chem. Soc. 1952, 1561-71, and in U.S. Pat. No. 2,950,952;

Also suitable are the following zeolites:

K offretite, as described in EP-A-400,961;

zeolite R, as described in GB-A-841,812;

zeolite LZ-217, as described in U.S. Pat. No. 4,503,023;

Ca-free zeolite LZ-218, as described in U.S. Pat. No. 4,333,859;

zeolite T, zeolite LZ-220, as described in U.S. Pat. No. 4,503,023;

Na₃K6Al₉Si₂₇O₇₂.21 H₂O [zeolite L];

zeolite LZ-211, as described in U.S. Pat. No. 4,503,023;

zeolite LZ-212, as described in U.S. Pat. No. 4,503,023;

zeolite O, zeolite LZ-217, as described in U.S. Pat. No. 4,503,023;

zeolite LZ-219, as described in U.S. Pat. No. 4,503,023;

zeolite Rho, zeolite LZ-214, as described in U.S. Pat. No. 4,503,023;

zeolite ZK-19, as described in Am. Mineral. 54 1607 (1969);

zeolite W (K-M), as described in Barrer et al., J. Chem. Soc. 1956, 2882,

Na₃₀Al₃₀Si₆₆O₁₉₂.98H₂O [zeolite ZK-5, zeolite Q]

Particular preference is given to zeolite P grades of the above formula in which x is from 2 to 5 and y is from 3.5 to 10, and very particular preference is given to zeolite MAP of the stated formula in which x is 2 and y is from 3.5 to 10. In particular, the zeolite concerned is zeolite Na—P, i.e. M is Na. This zeolite generally occurs in the variants Na—P-1-, Na—P-2 and Na—P-3, which differ in their cubic, tetragonal or orthorhombic structure (R. M. Barrer, B. M. Munday, J. Chem. Soc. A 1971, 2909-14). The literature reference just referred to also describes the preparation of zeolite P-1 and P-2. According to that reference, zeolite P-3 is very rare and is therefore of virtually no practical interest. The structure of the zeolite P-1 corresponds to the gismondite structure known from the abovementioned Atlas of Zeolite Structures. In recent literature (EP-A-0 384 070) a distinction is made between cubic (zeolite B or P_{c}) and tetragonal (zeolite P₁) zeolites of the P type. Also mentioned therein are relatively new zeolites of the P type having Si:Al ratios below 1.07:1. These are zeolites having the designation MAP or MA-P, for “Maximum Aluminum P”. Depending on the preparation process, zeolite P may also include small fractions of other zeolites. Highly pure zeolite P has been described in WO-A-94/26662.

Within the scope of the invention it is also possible to use those finely divided, water-insoluble sodium aluminosilicates which have been precipitated and crystallized in the presence of water-soluble organic or inorganic dispersants. These can be introduced into the reaction mixture in any desired manner, prior to or during the precipitation and crystallization.

Very particular preference is given to Na zeolite A and Na zeolite P.

Further preference is given to zeolites with an extremely small particle size, particularly of the Na-A-type and Na—P type, such as are also described in U.S. Pat. No. 6,096,820.

The hydrotalcites and/or zeolites can be employed in amounts, for example, from 0.1 to 20, advantageously from 0.1 to 10 and, in particular, from 0.1 to 5 parts by weight per 100 parts by weight of halogen-containing polymer.

Hydroxycarboxylate metal salts: Additionally present may be hydroxycarboxylate metal salts, in which the metal can be an alkali or alkaline earth metal or aluminum. Preference is given to sodium, potassium, magnesium or calcium. The hydroxycarboxylic acid may be glycolic, lactic, malic, tartaric or citric acid or salicylic or 4-hydroxybenzoic acid, or else glyceric, gluconic and saccharic acid (see PS GB 1,694,873).

beta-Diketones, beta-keto esters: 1,3-dicarbonyl compounds which can be used may be linear or cyclic dicarbonyl compounds. Preference is given to the use of dicarbonyl compounds of the following formula: R′₁CO CHR′₂—COR′₃ in which R′₁ is C₁-C₂₂-alkyl, C₅-C₁₀-hydroxyalkyl, C₂-C₁₈-alkenyl, phenyl, OH—, C₁-C₄-alkyl-, C₁-C₄-alkoxy- or halogen-substituted phenyl, C₇-C₁₀-phenylalkyl, C₅-C₁₂-cycloalkyl, C₁-C₄-alkyl-substituted C₅-C₁₂-cycloalkyl or a group —R′₅—S—R′₆ or —R′₅—O—R′₆, R′₂ is hydrogen, C₁-C₈-alkyl, C₂-C₁₂-alkenyl, phenyl, C₇-C₁₂-alkylphenyl, C₇-C₁₀-phenylalkyl or a group —CO—R′₄, R′₃ is as defined for R′₁ or is C₁-C₁₈-alkoxy, R′₄ is C₁-C₄-alkyl or phenyl, R′₅ is C₁-C10-alkylene and R′₆ is C₁-C₁₂-alkyl, phenyl, C₇-C₁₈-alkylphenyl or C₇-C₁₀-phenylalkyl.

These include the hydroxyl-containing diketones of EP-A-0 346 279 and the oxa and thia diketones of EP-A-0 307 358, as well as the keto esters based on isocyanic acid, of U.S. Pat. No. 4,339,383.

R′₁ and R′₃ as alkyl can in particular be C₁-C₁₈-alkyl, such as, for example 15 methyl, ethyl, n-propyl, isopropyl, n-butyl, tert-butyl, pentyl, hexyl, heptyl, octyl, decyl, dodecyl or octadecyl.

R′₁ and R′₃ as hydroxyalkyl are in particular a group —(CH₂)ₙ—OH in which n is 5, 6 or 7.

R′₁ and R′₃ as alkenyl can for example be vinyl, allyl, methallyl, 1-butenyl, 1-hexenyl or oleyl, preferably allyl.

R′₁ and R′₃ as OH—, alkyl-, alkoxy- or halogen-substituted phenyl can for example be tolyl, xylyl, tert-butylphenyl, methoxyphenyl, ethoxyphenyl, hydroxyphenyl, chlorophenyl or dichlorophenyl.

R′₁ and R′₃ as phenylalkyl are in particular benzyl. R′₂ and R′₃ as cycloalkyl or alkylcycloalkyl are, in particular, cyclohexyl or methylcyclohexyl.

R′₂ as alkyl can in particular be C₁-C₄-alkyl. R′₂ as C₂-C₁₂-alkenyl can in particular be allyl. R′₂ as alkylphenyl can in particular be tolyl. R′₂ as phenylalkyl can in particular be benzyl. Preferably, R′₂ is hydrogen. R′₃ as alkoxy can for example be methoxy, ethoxy, butoxy, hexyloxy, octyloxy, dodecyloxy, tridecyloxy, tetradecyloxy or octadecyloxy. R′₅ as C₁-C₁₀-alkylene is, in particular, C₂-C₄-alkylene. R′₆ as alkyl is, in particular, C₄-C₁₂-alkyl, such as, for example butyl, hexyl, octyl, decyl or dodecyl. R′₆ as alkylphenyl is in particular tolyl. R′6 as phenylalkyl is in particular benzyl.

Examples of 1,3-dicarbonyl compounds of the above formula and their alkali metal, alkaline earth metal and zinc chelates are acetylacetone, butanoylacetone, heptanoylacetone, steroylacetone, palmitoylacetone, lauroylacetone, 7-tert-nonylthio-2,4-heptanedione, benzoylacetone, dibenzoylmethane, lauroylbenzoylmethane, palmitoylbenzoylmethane, stearoylbenzoylmethane, isooctylbenzoylmethane, 5-hydroxycapronylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, 1-benzoyl-1-acetylnonane, benzoylacetylphenylmethane, stearoyl-4-methoxybenzoylmethane, bis(4-tert-butylbenzoyl)methane, benzoylformylmethane, benzoylphenylacetylmethane, biscyclohexanoylmethane, di-pivaloylmethane, 2-acetylcyclopentanone, 2-benzoylcyclopentanone, methyl, ethyl and allyl diacetoacetate, methyl and ethyl benzoyl-, propionyl- and butyrylacetoacetate, triacetylmethane, methyl, ethyl, hexyl, octyl, dodecyl or octadecyl acetoacetate, methyl, ethyl, butyl, 2-ethylhexyl, dodecyl or octadecyl benzoylacetate, and also C₁-C₁₈-alkyl propionylacetates and butyrylacetates; ethyl, propyl, butyl, hexyl or octyl stearoylacetate, and also polycyclic B-keto esters, as described in EP-A-0 433 230, and dehydraacetic acid, and the zinc, magnesium or alkali metal 20 salts thereof.

Preference is given to Ca, Mg and Zn salts of acetylacetone and of dehydracetic acid. Particular preference is given to 1,3-diketo compounds of the above formula in which R′₁ is C₁-C₁₈-alkyl, phenyl, OH—, methyl- or methoxy-substituted phenyl, C₇-C₁₀-phenylalkyl or cyclohexyl, R′₂ is hydrogen and R′₃ is as defined for R′₁.

The 1,3-diketo compounds can be employed in an amount of, for example, from 0.01 to 10, advantageously from 0.01 to 3 and, in particular, from 0.01 to 2 parts by weight per 100 parts by weight of PVC.

Further N-containing stabilizers: Ureas, especially phenylurea and diphenylurea, indoles, (such as 2-phenylindoles), aminophenols, β-aminocrotonic esters (such as the bis esters of 1,4-butanediol and of thiodiglycol) and pyrroles (especially 2-pyrrolecarboxylic acid, 2,4-diphenylpyrrole and 2-alkyl-4-phenyl-pyrrole-3-carboxylic esters).

1,3-Disubstituted 6-aminouracils: These may where appropriate be obtained as by-products in the synthesis of compounds of the formula (I) and for the application are not separated off but used concomitantly. Preference is given to the binary combinations: monopropyl- and dipropyl-, monobutyl- and dibutyl-, monohexyl- and dihexyl-, monooctyl- and dioctyl-, monoallyl- and diallyl-, monobenzyl- and dibenzyl-, mono-3-methoxypropyl- and bis-3-methoxypropyl- and also mono-2-phenethyl- and bis-2-phenethyl-6-aminouracil.

Further, customary additives can also be added to the compositions of the invention, such as stabilizers, auxiliaries and processing aids, examples being alkali metal compounds and alkaline earth metal compounds, lubricants, plasticizers, pigments, fillers, phosphites, thiophosphites and thiophosphates, mercaptocarboxylic esters, epoxidized fatty acid esters, antioxidants, UV absorbers and light stabilizers, optical brighteners, impact modifiers and processing aids, gelling agents, antistats, biocides, metal passivators, flame retardants and blowing agents, antifog agents, compatibilizers and antiplateout agents. (cf. “Handbook of PVC Formulating” by E. J. Wickson, John Wiley & Sons, New York 1993). Examples of such additives are as follows:

I. Fillers: Fillers (HANDBOOK OF PVC FORMULATING E. J. Wickson, John Wiley & Sons, Inc., 1993, pp. 393-449) and reinforcing agents (Plastics Additives Handbook H. Zweifel., Carl Hanser, 5^{th} ed., 2001, pp. 901-948) are, for example, calcium carbonate, dolomite, wollastonite, magnesium oxide, magnesium hydroxide, silicates, china clay, talc, glass fibers, glass beads, wood flour, mica, metal oxides, or metal hydroxides, carbon black, graphite, rock flour, heavy spar, glass fibers, talc, kaolin and chalk. Chalk is preferred. The fillers can be employed in an amount of preferably at least 1 part, for example, from 5 to 200, advantageously from 10 to 150 and, in particular, from 15 to 100 parts by weight per 100 parts by weight of PVC.

II. Metal soaps: Metal soaps are primarily metal carboxylates of preferably relatively long-chain carboxylic acids. Familiar examples are stearates and laurates, and also oleates and salts of shorter-chain alkanecarboxylic acids.

Alkylbenzoic acids are also said to be included under metal soaps. Metals which may be mentioned are Li, Na, K, Mg, Ca, Sr, Ba, Zn, Al, La, Ce and rare earth metals. Use is often made of what are known as synergistic mixtures, such as barium/zinc, magnesium/zinc, calcium/zinc or calcium/magnesium/zinc stabilizers. The metal soaps can be employed individually or in mixtures, in particular Ca stearate, Mg laurate or stearate. A review of common metal soaps is given in Ullmann's Encyclopedia of Industrial Chemistry, 5^{th} Ed., Vol. A16 (1985), p. 361 ff.). It is advantageous to use organic metal soaps from the series of the aliphatic saturated C₂-C₂₂ carboxylates, the aliphatic unsaturated C₃-C₂₂ carboxylates, the aliphatic C₂-C₂₂ carboxylates substituted by at least one OH group, the cyclic and bicyclic carboxylates having 5-22 carbon atoms, the unsubstituted benzenecarboxylates substituted by at least one OH group and/or by C₁-C₁₆-alkyl, the unsubstituted naphthalenecarboxylates substituted by at least one OH group and/or by C₁-C₁₆-alkyl, the phenyl C₁-C₁₆-alkylcarboxylates, the naphthyl C₁-C₁₆-alkylcarboxylates or the unsubstituted or C₁-C₁₂-alkyl-substituted phenolates, tallates and resinates.

Named examples which may be mentioned are the zinc, calcium, magnesium or barium salts of monovalent carboxylic acids such as acetic, propionic, butyric, valeric, hexanoic, enanthic, octanoic, neodecanoic, 2-ethylhexanoic, pelargonic, decanoic, undecanoic, dodecanoic, tridecanoic, myristic, palmitic, isostearic, stearic, 1 2-hydroxystearic, behenic, benzoic, p-tert-butylbenzoic, N,N-dimethylhydroxybenzoic, 3,5-di-tert-butyl-4-hydroxybenzoic, toluic, dimethylbenzoic, ethylbenzoic, n-propylbenzoic, salicylic, p-tert-octylsalicylic and sorbic acid; calcium, magnesium and zinc salts of the monoesters of divalent carboxylic acids such as oxalic, malonic, succinic, glutaric, adipic, fumaric, pentane-1,5-dicarboxylic, hexane-1,6-dicarboxylic, heptane-1,7-dicarboxylic, octane-1,8-dicarboxylic, phthalic, isophthalic, terephthalic and hydroxyphthalic acid; and of the di- or triesters of tri- or tetravalent carboxylic acids such as hemimellitic, trimellitic, pyromellitic and citric acid.

Preference is given to calcium, magnesium and zinc carboxylates of carboxylic acids having 7 to 18 carbon atoms (metal soaps in the narrow sense), such as, for example, benzoates or alkanoates, preferably stearate, oleate, laurate, palmitate, behenate, hydroxystearates, dihydroxystearates or 2-ethylhexanoate. Particular preference is given to stearate, oleate and p-tert-butylbenzoate. Overbased carboxylates, such as overbased zinc octoate, are also preferred. Preference is likewise given to overbased calcium soaps.

If desired, it is also possible to employ a mixture of carboxylates of different structures.

Preference is given to compositions, as described, comprising an organozinc and/or organocalcium compound.

In addition to the compounds mentioned, organoaluminum compounds are also suitable, as are compounds analogous to those mentioned above, especially aluminum tristearate, aluminum distearate and aluminum monostearate, and also aluminum acetate and basic derivatives derived therefrom.

Further information on the aluminum compounds which can be used and are preferred is given in U.S. Pat. No. 4,060,512 and U.S. Pat. No. 3,243,394.

Also suitable in addition to the compounds already mentioned are organic rare earth compounds, especially compounds analogous to those mentioned above. The term rare earth compound means especially compounds of the elements cerium, praseodymium, neodymium, samarium, europium, gadolinium, terbium, dysprosium, holmium, erbium, thulium, ytterbium, lutetium, lanthanum and yttrium, mixtures—especially with cerium—being preferred. Further preferred rare earth compounds can be found in EP-A-0 108 023.

It is possible if desired to employ a mixture of zinc, alkali metal, alkaline earth metal, aluminum, cerium, lanthanum or lanthanoid compounds of different structure. It is also possible for organozinc, organoaluminum, organocerium, organo-alkali metal, organo-alkaline earth metal, organolanthanum or organolanthanoid compounds to be coated on an alumo salt compound; in this regard see also DE-A-4 031 818.

The metal soaps and/or mixtures thereof can be employed in an amount of, for example, from 0.001 to 10 parts by weight, advantageously from 0.01 to 8 parts and, with particular preference, from 0.05 to 5 parts by weight per 100 parts by weight of PVC. The same applies to the further metal stabilizers:

III. Further metal stabilizers: Here, mention may be made in particular of the organotin stabilizers. These can be the carboxylates, mercaptides and sulfides, in particular. Examples of suitable compounds are described in U.S. Pat. No. 4,743,640.

IV. Alkali metal and alkaline earth metal compounds: By these are meant principally the carboxylates of the above-described acids, but also corresponding oxides and/or hydroxides or carbonates. Also suitable are mixtures thereof with organic acids. Examples are LiOH, NaOH, KOH, CaO, Ca(OH₂), MgO, Mg(OH)₂, Sr(OH)₂, Al(OH)₃, CaCO₃ and MgCO₃ (also basic carbonates, such as magnesia alba and huntite), and also Na and K salts of fatty acids. In the case of alkaline earth metal and Zn carboxylates it is also possible to employ their adducts with MO or M(OH)₂ (M=Ca, Mg, Sr or Zn), known as “overbased” compounds. In addition to the stabilizer combination of the invention it is preferred to employ alkali metal carboxylates, alkaline earth metal carboxylates and/or aluminum carboxylates.

V. Lubricants: Examples of suitable lubricants are montan wax, fatty acid esters, PE waxes, amide waxes, chlorinated paraffins, glycerol esters or alkaline earth metal soaps, especially Ca stearate. Lubricants which can be used are also described in “Plastics Additives Handbook”, H. Zweifel, Carl Hanser Verlag, 5th Ed., 2001, pages 551-552. Mention may also be made of fatty ketones (as described in DE-A-4 204 887) and of silicone-based lubricants (as described in EP-A-0 225 261) or combinations thereof, as set out in EP-A-0 259 783. The lubricants can also be applied to an alumo salt compound; in this regard see also DE-A-4 031 818.

VI. Plasticizers Examples of suitable organic plasticizers are those from the following groups:

A) Phthalates: examples of such plasticizers are dimethyl, diethyl, dibutyl, dihexyl, di-2-ethylhexyl, di-n-octyl, diisooctyl, diisononyl, diisodecyl, diisotridecyl, dicyclohexyl, dimethylcyclohexyl, dimethylglycol, dibutylglycol, benzyl butyl and diphenyl phthalate, and also mixures of phthalates, such as C₇-C₉- and C₉-C₁₁-alkyl phthalates obtained from predominantly linear alcohols, C₆-C₁₀-n-alkyl phthalates and C₈-C₁₀-n-alkyl phthalates; Of these preference is given to dibutyl, dihexyl, di-2-ethylhexyl, di-n-octyl, diisooctyl, diisononyl, diisodecyl, diisotridecyl and benzyl butyl phthalate, and the stated mixtures of alkyl phthalates. Particular preference is given to di-2-ethylhexyl, diisononyl and diisodecyl phthalate, which are also known by the common abbreviations DOP (dioctyl phthalate, di-2-ethylhexyl phthalate), DINP (diisononyl phthalate) and DIDP (diisodecyl phthalate).

B) Esters of aliphatic dicarboxylic acids, especially esters of adipic, azelaic and sebacic acid: examples of such plasticizers are di-2-ethylhexyl adipate, diisooctyl adipate (mixture), diisononyl adipate (mixture), diisodecyl adipate (mixture), benzyl butyl adipate, benzyl octyl adipate, di-2-ethylhexyl azelate, di-2-ethylhexyl sebacate and diisodecyl sebacate (mixture). Di-2-ethylhexyl adipate and diisooctyl adipate are preferred.

C) Trimellitates, examples being tri-2-ethylhexyl trimellitate, triisodecyl trimellitate (mixture), triisotridecyl trimellitate, triisooctyl trimellitate (mixture) and also tri-C₆-C₈-alkyl, tri-C₆-C₁₀-alkyl, tri-C₇-C₉-alkyl- and tri-C₉-C₁₁-alkyl trimellitates. The latter trimellitates are formed by esterification of trimellitic acid with the corresponding alkanol mixtures. Preferred trimellitates are tri-2-ethylhexyl trimellitate and the abovementioned trimellitates from alkanol mixtures. Customary abbreviations are TOTM (trioctyl trimellitate, tri-2-ethyl-hexyl trimellitate), TIDTM (triisodecyl trimellitate) and TITDTM (triisotridecyl trimellitate).

D) Epoxy plasticizers: these are primarily epoxidized unsaturated fatty acids, such as epoxidized soybean oil.

E) Polymer plasticizers: a definition of these plasticizers and examples of them are given in “Kunststoffadditive”, R. Gächter/H. Müller, Carl Hanser Verlag, 3rd ed., 1989, section 5.9.6, pages 412-415, and also in “PVC Technology”, W. V. Titow, 4th ed., Elsevier Publ., 1984, pages 165-170. The most common starting materials for preparing the polyester plasticizers are dicarboxylic acids, such as adipic, phthalic, azelaic and sebacic acids; diols, such as 1,2-propanediol, 1,3-butanediol, 1,4-butanediol, 1,6-hexanediol, neopentyl glycol and diethylene glycol.

F) Phosphoric esters: a definition of these esters is given in the abovementioned “Taschenbuch der Kunststoffadditive” section 5.9.5, pp. 408-412. Examples of such phosphoric esters are tributyl phosphate, tri-2-ethylbutyl phosphate, tri-2-ethylhexyl phosphate, trichloroethyl phosphate, 2-ethylhexyl diphenyl phosphate, cresyl diphenyl phosphate, triphenyl phosphate, tricresyl phosphate and trixylenyl phosphate. Preference is given to tri-2-ethylhexyl phosphate and to ®Reofos 50 and 95 (Ciba Spezialitätenchemie).

G) Chlorinated hydrocarbons (paraffins)

H) Hydrocarbons

I) Monoesters, e.g., butyl oleate, phenoxyethyl oleate, tetrahydrofurfuryl oleate and alkylsulfonic esters.

J) Glycol esters, e.g., diglycol benzoates.

K) Citric esters, e.g., tributyl citrate and acetyl tributyl citrate, as described in WO-A-02/05206

L) Perhydrophthalic, perhydroisophthalic and perhydroterephthalic esters and also perhydroglycol and perhydrodiglycol benzoate esters. Preference is given to perhydro-diisononyl phthalate (®Hexamoll DINCH—BASF) as described in DE-A-19 756913, DE-A-19 927 977, DE-A-19 927 978 and DE-A-19 927 979.

Definitions and examples of plasticizers of groups G) to J) are given in the following handbooks:

“Kunststoffadditive”, R. Gächter/H. Müller, Carl Hanser Verlag, 3rd ed., 1989, section 5.9.14.2, pp. 422-425, (group G), and section 5.9.14.1, p. 422, (group H).

“PVC Technology”, W. V. Titow, 4th ed., Elsevier Publishers, 1984, section 6.10.2, pages 171-173, (group G), section 6.10.5 page 174, (group H), section 6.10.3, page 173, (group I) and section 6.10.4, pages 173-174 (group J).

It is also possible to use mixtures of different plasticizers. The plasticizers can be employed in an amount of, for example, from 5 to 20 parts by weight, advantageously from 10 to 20 parts by weight, per 100 parts by weight of PVC. Rigid or semirigid PVC contains preferably up to 10%, with particular preference up to 5%, or no plasticizer.

VII. Pigments, Suitable substances are known to the person skilled in the art. Examples of inorganic pigments are TiO₂, zirconium oxide-based pigments, BaSO₄, zinc oxide (zinc white) and lithopones (zinc sulfide/barium sulfate), carbon black, carbon black/titanium dioxide mixtures, iron oxide pigments, Sb₂O₃, (Ti,Ba,Sb)O₂, Cr₂O₃, spinels, such as cobalt blue and cobalt green, Cd(S,Se), ultramarine blue. Organic pigments are, for example, azo pigments, phthalocyanine pigments, quinacridone pigments, perylene pigments, diketopyrrolopyrrole pigments and anthraquinone pigments. Preference is also given to TiO₂ in micronized form. A definition and further descriptions are given in “Handbook of PVC Formulating”, E. J. Wickson, John Wiley & Sons, New York, 1993.

VIII. Phosphites (phosphorous triesters): Examples are triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl) pentaerythritol diphosphite, bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tristearyl sorbitol triphosphite, bis(2,4-di-tert-butyl-6-methylphenyl) methyl phosphite, bis(2,4-di-tert-butyl-6-methylphenyl) ethyl phosphite. Particularly suitable are trioctyl, tridecyl, tridodecyl, tritetradecyl, tristearyl, trioleyl, triphenyl, tricresyl, tris-p-nonylphenyl or tricyclohexyl phosphite and, with particular preference, the aryl dialkyl and alkyl diaryl phosphites, examples being phenyl didecyl, 2,4-di-tert-butylphenyl didodecyl phosphite, 2,6-di-tert-butylphenyl didodecyl phosphite and the dialkyl and diaryl pentaerythritol diphosphites, such as distearyl pentaerythritol diphosphite, and also nonstoichiometric triaryl phosphites whose composition is, for example, (H₁₉C₉-C₆H₄)O_{1.5}P(OC_{12,13}H_{25,27})_{1.5} or (H₈C₁₇-C₆H₄)O₂P(i-C₈H₁₇O) or (H₁₉C₉-C₆H₄)O_{1.5}P(OC_{9,11}H_{19,23})_{1.5} or

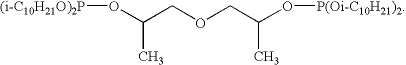

Preferred organic phosphites are distearyl pentaerythritol diphosphite, trisnonylphenyl phosphite and phenyl didecyl phosphite. Other suitable phosphites are phosphorous diesters (with abovementioned radicals) and phosphorous monoesters (with abovementioned radicals), possibly in the form of their alkali metal, alkaline earth metal, zinc or aluminum salts. It is also possible for these phosphorous esters to have been applied to an alumo salt compound; in this regard see also DE-A-4 031 818.

The organic phosphites can be employed in an amount of, for example, from 0.01 to 10, advantageously from 0.05 to 5 and, in particular, from 0.1 to 3 parts by weight per 100 parts by weight of PVC.

IX. Thiophosphites and thiophosphates: By thiophosphites and thiophosphates are meant compounds of the general type (RS)₃P, (RS)₃P═O and (RS)₃P═S, respectively, as are described, for instance, in the patents DE-A-2 809 492, EP-A-0 090 770 and EP-A-0 573 394. Examples of these compounds are trithiohexyl phosphite, trithiooctyl phosphite, trithiolauryl phosphite, trithiobenzyl phosphite, trithiophosphorous acid tris(carbo-i-octyl-oxy)methyl ester, trithiophosphorous acid tris(carbotrimethylcyclohexyloxy)-methyl ester, trithiophosphoric acid S,S,S-tris(carbo-i-octyloxy)methyl ester, trithiophosphoric acid S,S,S-tris(carbo-2-ethylhexyloxy)methyl ester, trithiophosphoric acid S,S,5S-tris-1-(carbohexyloxy)ethyl ester, trithiophosphoric acid S,S,S-tris-1-(carbo-2-ethylhexyloxy)ethyl ester and trithiophosphoric acid S,S,S-tris-2-(carbo-2-ethylhexyloxy)ethyl ester.

X. Mercaptocarboxylic esters: Examples of these compounds are esters of thioglycolic acid, thiomalic acid, mercaptopropionic acid, of the mercaptobenzoic acids and thiolactic acid, mercaptoethyl stearate and mercaptoethyl oleate, as are described in patents FR-A-2 459 816, EP-A-0 090 748, FR-A-2 552 440 and EP-A-0 365 483. The generic mercaptocarboxylic esters also embrace polyol esters and partial esters thereof, and also thioethers derived from them.

XI. Epoxidized fatty acid esters and other epoxy compounds: The stabilizer combination of the invention may additionally comprise preferably at least one epoxidized fatty acid ester. Particularly suitable such esters are those of fatty acids from natural sources (fatty acid glycerides), such as soybean oil or rapeseed oil. It is, however, also possible to employ synthetic products such as epoxidized butyl oleate. Epoxidized polybutadiene and polyisoprene can also be used, as they are or in partially hydroxylated form, or else homo- or copolymeric glycidyl acrylate and glycidyl methacrylate can be used. These epoxy compounds can also have been applied to an alumo salt compound; in this regard see also DE-A-4 031 818.

XII. Antioxidants Examples of Suitable Such Compounds Are:

Alkylated monophenols, for example, 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-iso-butylphenol, 2,6-di-cyclopentyl-4-methylphenol, 2-(alpha-methylcyclohexyl)-4,6-dimethylphenol, 2,6-di-octadecyl-4-methylphenol, 2,4,6-tricyclohexylphenol, 2,6-di-tert-butyl-4-methoxy-methylphenol, 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol, octylphenol, nonylphenol, dodecylphenol and mixtures thereof.

Alkylthiomethylphenols, for example, 2,4-dioctylthiomethyl-6-tert-butyl-phenol, 2,4-dioctylthiomethyl-6-methylphenol, 2,4-dioctylthiomethyl-6-ethyl-phenol, 2,6-didodecylthiomethyl-4-nonylphenol.

Alkylated hydroquinones, for example, 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

Hydroxylated thiodiphenyl ethers, for example, 2,2′-thiobis(6-tert-butyl-4-methylphenol), 2,2′-thiobis(4-octylphenol), 4,4′-thiobis(6-tert-butyl-3-methyl-phenol), 4,4′-thiobis(6-tert-butyl-2-methylphenol), 4,4′-thiobis(3,6-di-sec-amylphenol), 4,4′-bis(2,6-dimethyl-4-hydroxyphenyl) disulfide.

Alkylidenebisphenols, for example, 2,2′-methylenebis(6-tert-butyl-4-methylphenol), 2,2′-methylenebis(6-tert-butyl-4-ethylphenol), 2,2′-methylene-bis[4-methyl-6-(alpha-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(alpha-methylbenzyl)-4-nonylphenol], 2,2′-methylenebis[6-(alpha,alpha-di-methylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis-(5-tert-butyl-4-hydroxy-2-methylphenyl)-3-n-dodecylmercaptobutane, ethylene glycol bis[3,3-bis-(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis(4-hydroxyphenyl)propane, 2,2-bis(5-tert-butyl-4-hydroxy-2-methyl-phenyl)-4-n-dodecylmercaptobutane, 1,1,5,5-tetra(5-tert-butyl-4-hydroxy-2-methylphenyl)pentane.

Benzyl compounds, for example, 3,5,3′,5′-tetra-tert-butyl-4,4′-dihydroxy-dibenzyl ether, octadecyl 4-hydroxy-3,5-dimethylbenzyl-mercaptoacetate, tris-(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl) sulfide, isooctyl 3,5-di-tert-butyl-4-hydroxybenzyl-mercaptoacetate.

Hydroxybenzylated malonates, for example, dioctadecyl 2,2-bis(3,5-di-tert-butyl-2-hydroxybenzyl)malonate, dioctadecyl 2-(3-tert-butyl-4-hydroxy-5-methylbenzyl)malonate, didodecyl mercaptoethyl-2,2-bis(3,5-di-tert-butyl-4-hydroxybenzyl)malonate, di[4-(1,1,3,3-tetramethylbutyl)phenyl]2,2-bis(3,5-di-tert-butyl-4-hydroxybenzyl)malonate.

Aromatic hydroxybenzyl compounds, for example, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

Triazine compounds, for example, 2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl)isocyanurate.

Phosphonates and phosphonites, for example, dimethyl 2,5-di-tert-butyl-4-hydroxybenzylphosphonate, diethyl 3,5-di-tert-butyl-4-hydroxy-benzyl-phosphonate, dioctadecyl 3,5-di-tert-butyl-4-hydroxybenzylphosphonate, dioctadecyl 5-tert-butyl-4-hydroxy-3-methylbenzylphosphonate, Ca salt of monoethyl 3,5-di-tert-butyl-4-hydroxybenzylphosphonate, tetrakis(2,4-di-tert-butylphenyl)-4,4′-biphenylenediphosphonite, 6-isooctyloxy-2,4,8,10-tetra-tert-butyl-12H-dibenz[d,g]-1,3,2-dioxaphosphocine, 6-fluoro-2,4,8,10-tetra-tert-butyl-12-methyl-dibenz[d,g]-1,3,2-dioxaphosphocine.

Acylaminophenols, for example, 4-hydroxylauranilide, 4-hydroxystearanilide, octyl N-(3,5-di-tert-butyl-4-hydroxyphenyl)carbamate.

Esters of beta-(3,5-di-tert-butyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propane diol, neopentyl glycol, thiodiethylene glycol, diethylene glycol, triethylene glycol, pentaerythritol, dipentaerythritol, tris(hydroxyethyl) isocyanurate, N,N′-bis-(hydroxyethyl)oxalamide, 3-thiaundecanol, 3-thiapentadecanol, trimethyl-hexanediol, trimethylolpropane, ditrimethylolpropane, 4-hydroxymethyl-1-phospha-2,6,7-trioxabicyclo[2.2.2]octane.

Esters of beta-(5-tert-butyl-4-hydroxy-3-methylphenyl)propionic acid with mono- or polyhydric alcohols, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy)ethyl isocyanurate, N,N′-bis(hydroxyethyl)oxalamide, 3-thiaundecanol, 3-thiapentadecanol, trimethylhexanediol, trimethylol-propane, 4-hydroxymethyl-1-phospha-2,6,7-trioxabicyclo[2.2.2]octane.

Esters of beta-(3,5-dicyclohexyl-4-hydroxyphenyl)propionic acid with mono- or polyhydric alcohols, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy)ethyl isocyanurate, N,N′-bis(hydroxyethyl)oxalamide, 3-thiaundecanol, 3-thiapentadecanol, trimethylhexanediol, trimethylol-propane, 4-hydroxymethyl-1-phospha-2,6,7-trioxabicyclo[2.2.2]octane.

Esters of 3.5-di-tert-butyl-4-hydroxyphenylacetic acid with mono- or polyhydric alcohols, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy)ethyl isocyanurate, N,N′-bis(hydroxyethyl)oxalamide, 3-thiaundecanol, 3-thiapentadecanol, trimethylhexanediol, trimethylol-propane, 4-hydroxymethyl-1-phospha-2,6,7-trioxabicyclo[2.2.2]octane.

Amides of beta-(3,5-di-tert-butyl-4-hydroxyphenyl)propionic acid, such as, for example, N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

Vitamin D (tocopherol) and derivatives.

Preference is given to antioxidants of groups 1-5, 10 and 12, especially 2,2-bis(4-hydroxyphenyl)propane, esters of 3,5-di-tert-butyl-4-hydroxyphenyl-propionic acid with octanol, octadecanol or pentaerythritol or tris(2,4-di-tert-butylphenyl)phosphite.

It is also possible, if desired, to employ a mixture of antioxidants of different structures.

The antioxidants can be employed in an amount of, for example, from 0.01 to 10 parts by weight, advantageously from 0.1 to 10 parts by weight and in particular, from 0.1 to 5 parts by weight per 100 parts by weight of PVC. More precise remarks relating to antioxidants (definition, examples) can be found in “Plastics Additives Handbook”, H. Zweifel, Carl Hanser Verlag, 5th ed., 2001, pages 1-139.

XIII. UV Absorbers and Light Stabilizers: Examples of These Are:

2-(-2-′-Hydroxyphenyl)benzotriazoles as pure substances or in mixtures; such as, for example 2-(2′-hydroxy-5′-methylphenyl)benzotriazole, 2-(3′,5′-di-tert-butyl-2′-hydroxyphenyl)benzo-triazole, 2-(5′-tert-butyl-2′-hydroxyphenyl)-benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxyl-4′-octoxyphenyl)benzotriazole, 2-(3′,5′-di-tert-amyl-2′-hydroxyphenyl)benzotriazole, 2-(3′,5′-bis(alpha alpha-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chloro-benzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the transesterification product of 2-[3′-tert-butyl-5′-(2-methoxycarbonylethyl)-2′-hydroxyphenyl]benzotriazole with polyethylene glycol 300;
[R—CH₂CH₂—COO—CH₂CH₂ [symbol] ₂
where R=3′-tert-butyl-4′-hydroxy-5′-2H-benzotriazol-2-yl-phenyl.

2-Hydroxybenzophenones, for example the 4-hydroxy, 4-methoxy, 4-octoxy, 4-decyloxy, 4-dodecyloxy, 4-benzyloxy, 4,2′,4′-trihydroxy, 2′-hydroxy-4,4′-dimethoxy derivative.

Esters of substituted or unsubstituted benzoic acids, for example 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxy-benzoate.

Acrylates, for example ethyl alpha-cyano-beta,beta-diphenylacrylate or isooctyl-ethyl alpha-cyano-beta,beta-diphenylacrylate, methyl alpha-carbo-methoxycinnamate, methyl alpha-cyano-beta-methyl-p-methoxycinnamate or butyl alpha-cyano-beta-methyl-p-methoxycinnamate, methyl alpha-carbomethoxy-p-methoxycinnamate, N-(beta-carbomethoxy-b-cyanovinyl)-2-methyl-indoline.

Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of monoalkyl esters of 4-hydroxy-3,5-di-tert-butylbenzylphosphonic acid, such as of the methyl or ethyl ester, nickel complexes of ketoximes, such as of 2-hydroxy-4-methylphenyl undecyl ketoxime, nickel complexes of 1-phenyl-4-lauroyl-5-hydroxypyrazole, with or without additional ligands.

Oxalamides, for example 4,4′-dioctyloxyoxanilide, 2,2′-dioctyloxy-5,5′-di-tert-butyloxanilide, 2,2′-didodecyloxy-5,5′-di-tert-butyloxanilide, 2-ethoxy-2′-ethyloxanilide, N,N′-bis(3-dimethylaminopropyl)oxalamide, 2-ethoxy-5-tert-butyl-2′-ethyloxanilide and its mixture with 2-ethoxy-2′-ethyl-5,4′-di-tert-butyl-oxanilide, mixtures of o- and p-methoxy- and of o- and p-ethoxy-di-substituted oxanilides.

2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethyl-phenyl)-1,3,5-triazine, 2,4-bis(2-hydroxy-4-propyloxyphenyl)-6-(2,4-dimethyl-phenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis-(2,4-dimethylphenyl)-1,3,5-triazine, 2-[2-hydroxy-4-(2-hydroxy-3-octyloxypropyloxy)phenyl]-4,6-bis(2,4-dimethylphenyl)-1,3,5-triazine.

Sterically hindered amines, for example bis(2,2,6,6-tetramethylpiperidin-4-yl)sebacate, bis(2,2,6,6-tetramethylpiperidin-4-yl) succinate, bis(1,2,2,6,6-pentamethylpiperidin-4-yl)sebacate, bis(1-octyloxy-2,2,6,6-tetramethyl-piperidin-4-yl)sebacate, bis(1,2,2,6,6-pentamethylpiperidyl)n-butyl-3,5-di-tert-butyl-4-hydroxybenzylmalonate, the condensate of 1-hydroxyethyl-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-s-triazine, tris(2,2,6,6-tetramethyl-4-piperidyl) nitrilotriacetate, tetrakis(2,2,6,6-tetramethyl-4-piperidyl) 1,2,3,4-butanetetraoate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl) 2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl) succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-di-(4-n-butylamino-2,2,6,6-tetramethylpiperidyl)-1,3,5-triazine und 1,2-bis(3-aminopropylamino)ethane, the condensate of 2-chloro-4,6-di(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, mixture of 4-hexadecyloxy- and 4-stearyloxy-2,2,6,6-tetramethylpiperidine, the condensate of N,N′-bis(2,2,6,6-tetramethyl-4-piperidyl)hexamethylenediamine and 4-cyclohexylamino-2,6-dichloro-1,3,5-triazine, the condensate of 1,2-bis(3-aminopropylamino)ethane and 2,4,6-trichloro-1,3,5-triazine, and also 4-butylamino-2,2,6,6-tetramethylpiperidine (CAS Reg. No. [136504-96-6]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4.5]decane, the reaction product of 7,7,9,9-tetramethyl-2-cycloundecyl-1-oxa-3,8-diaza-4-oxospiro[4.5]decane and epichlorohydrin, 1,1-bis(1,2,2,6,6-pentamethyl-4-piperidyloxycarbonyl)-2-(4-methoxyphenyl)ethene, N,N′-bisformyl-N,N′-bis(2,2,6,6-tetramethyl-4-piperidyl)hexamethylenediamine, the diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]-siloxane, the reaction product of maleic anhydride-α-olefin copolymer and 2,2,6,6-tetramethyl-4-aminopiperidine or 1,2,2,6,6-pentamethyl-4-aminopiperidine. More precise remarks relating to this subject (definition, examples) can be found in “Plastics Additives Handbook”, H. Zweifel, Carl Hanser Verlag, 5th ed., 2001, pages 141-425.

XIV. Blowing agents: Examples of blowing agents are organic azo and hydrazo compounds, tetrazoles, oxazines, isatoic anhydride, and also sodium carbonate and sodium bicarbonate. Preference is given to azodicarboxamide and sodium bicarbonate and mixtures thereof.

Definitions and examples of impact modifiers and processing aids, gelling agents, antistats, biocides, metal passivators, optical brighteners, flame retardants, antifogging agents and compatibilizers are described in “Kunststoffadditive”, R. Gächter/H. Müller, Carl Hanser Verlag, 3rd ed., 1989, and in the “Handbook of Polyvinyl Chloride Formulating” E. J. Wickson, J. Wiley & Sons, 1993, and in “Plastics Additives” G. Pritchard, Chapman & Hall, London, 1st ed., 1998.

Impact modifiers are also described in detail in “Impact Modifiers for PVC”, J. T. Lutz/D. L. Dunkelberger, John Wiley & Sons, 1992.

Preference is further given to physiologically unobjectionable stabilizations using epoxidized fatty acid esters and/or trinonyl phosphate or distearyl pentaerythritol diphosphite and/or sodium perchlorates.

Further preferred, besides the binary combinations specified, are ternary and higher combinations such as, for example, zeolites and perchlorate salts, hydrotalcites and perchlorate salts, epoxidized fatty acid esters and perchlorate salts, glycidyl compounds and perchlorate salts, phosphites and perchlorate salts, calcium stearate and perchlorate salts, and magnesium laurate and perchlorate salts, or phosphites, epoxidized fatty acids and perchlorate salts; phosphites, glycidyl compounds and perchlorate salts; phosphites, zeolites and perchlorate salts; phosphites, hydrotalcites and perchlorate salts; calcium stearate, zeolites and perchlorate salts; calcium stearate, hydrotalcites and perchlorate salts, magnesium laurate, zeolites and perchlorate salts, and also the combination of these three-component mixtures with phosphites. Further combination partners which can be used include magnesium oxide, magnesium hydroxide, calcium oxide and calcium hydroxide.

Examples of the chlorine-containing polymers to be stabilized, or recyclates thereof, are: polymers of vinyl chloride and of vinylidene chloride, vinyl resins comprising vinyl chloride units in their structure, such as copolymers of vinyl chloride, and vinyl esters of aliphatic acids, especially vinyl acetate, copolymers of vinyl chloride with esters of acrylic and methacrylic acid and with acrylonitrile, copolymers of vinyl chloride with diene compounds and unsaturated dicarboxylic acids or their anhydrides, such as copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and others, such as acrolein, crotonaldehyde, vinyl methyl ketone, vinyl methyl ether, vinyl isobutyl ether and the like; polymers of vinylidene chloride and its copolymers with vinyl chloride and other polymerizable compounds; polymers of vinyl chloroacetate and dichlorodivinyl ether; chlorinated polymers of vinyl acetate, chlorinated polymeric esters of acrylic acid and of alpha-substituted acrylic acid; polymers of chlorinated styrenes, for example dichlorostyrene; chlorinated rubbers; chlorinated polymers of ethylene; polymers and post-chlorinated polymers of chlorobutadiene and copolymers thereof with vinyl chloride, chlorinated natural and synthetic rubbers, and also mixtures of these polymers with one another or with other polymerizable compounds. In the context of this invention, PVC also embraces copolymers with polymerizable compounds such as acrylonitrile, vinyl acetate or ABS, which can be suspension, bulk or emulsion polymers. Preference is given to a PVC homopolymer, alone or in combination with polyacrylates.

Also included are graft polymers of PVC with EVA, ABS and MBS (methyl methacrylate/butadiene/styrene). Preferred substrates are also mixtures of the abovementioned homo- and copolymers, especially vinyl chloride homopolymers, with other thermoplastic and/or elastomeric polymers, especially blends with ABS, MBS (methyl methacrylate/butadiene/styrene), NBR, SAN, EVA, CPE (chlorinated polyethylene), MBAS (methyl methacrylate-acrylonitrile-butadiene-styrene copolymer), PMA (polymethacrylate), PMMA (polymethyl methacrylate), EPDM (ethylene-propylene-diene copolymer) and polylactones.

Examples of such components are compositions of (i) 20-80 parts by weight of a vinyl chloride homopolymer (PVC) and (ii) 80-20 parts by weight of at least one thermoplastic copolymer based on styrene and acrylonitrile, in particular from the group ABS, NBR, NAR, SAN and EVA. The abbreviations used for the copolymers are familiar to the person skilled in the art and have the following meanings: ABS: acrylonitrile-butadiene-styrene; SAN: styrene-acrylonitrile; NBR: acrylonitrile-butadiene; NAR: acrylonitrile-acrylate; EVA: ethylene-vinyl acetate. Also suitable in particular are acrylate-based styrene-acrylonitrile copolymers (ASA). Preferred components in this context are polymer compositions comprising as components (i) and (ii) a mixture of 25-75% by weight of PVC and 75-25% by weight of the abovementioned copolymers. Examples of such compositions are: 25-50% by weight PVC and 75-50% by weight copolymers or 40-75% by weight PVC and 60-25% by weight copolymers. Preferred copolymers are ABS, SAN and modified EVA, especially ABS. NBR, NAR and EVA are also particularly suitable. In the composition of the invention it is possible for one or more of the abovementioned copolymers to be present. Particularly important components are compositions comprising (i) 100 parts by weight of PVC and (ii) 0-300 parts by weight of ABS and/or SAN-modified ABS and 0-80 parts by weight of the copolymers NBR, NAR and/or EVA, but especially EVA.

For stabilization in the context of this invention, further suitable polymers are, in particular, recyclates of chlorine-containing polymers or mixtures of recyclates with undamaged polymers as defined above, these polymers being the polymers described in more detail above that have also undergone damage through processing, use or storage. PVC recyclate is particularly preferred. The recyclates may also include small amounts of extraneous substances, such as, for example, paper, pigments, adhesives, which are often difficult to remove. These extraneous substances may also arise from contact with various materials in the course of use or reprocessing, examples being residues of fuel, fractions of coating material, traces of metal and residues of initiator.

Stabilization in accordance with the invention is of particular advantage in the context of PVC formulations such as are customary for pipes and profiles. Stabilization can be effected without heavy metal compounds (Sn, Pb, Cd, Zn stabilizers). This characteristic offers advantages in certain fields, since heavy metals—with the exception of zinc at best—are often unwanted both during the production and during the use of certain PVC articles, on ecological grounds. The production of heavy metal stabilizers also often causes problems from an industrial hygiene standpoint. Similarly, the processing of ores containing heavy metals is frequently associated with serious effects on the environment, the environment here including the biosystem of humankind, animals (fish), plants, the air and soil. For these reasons, the incineration and landfilling of plastics containing heavy metals is also contentious.

The invention also relates to a method of stabilizing PVC, characterized in that at least one of the abovementioned stabilizer combinations is added thereto.

The stabilizers can advantageously be incorporated by the following methods: as an emulsion or dispersion (one possibility, for example, is the form of a pastelike mixture. An advantage of the combination of the invention in the case of this form is the stability of the paste.); as a dry mix in the course of the mixing of additional components or polymer mixtures; by direct addition to the processing apparatus (e.g. calenders, mixers, compounders, extruders and the like), or as a solution or melt.

The PVC stabilized in accordance with the invention, to which the invention likewise relates, can be prepared in a manner known per se using devices known per se such as the abovementioned processing apparatus to mix the stabilizer combination of the invention and any further additives with the PVC. In this case, the stabilizers can be added individually or as a mixture or else in the form of so-called masterbatches.

The PVC stabilized in accordance with the present invention can be brought into the desired form by known methods. Examples of such methods are milling, calendering, extruding, injection molding or spinning, and also extrusion blow molding. The stabilized PVC can also be processed to foam materials.

A PVC stabilized in accordance with the invention is suitable, for example, for hollow articles (bottles), packaging films (thermoform sheets), blown films, pipes, foam materials, heavy profiles (window frames), transparent-wall profiles, construction profiles, sidings, fittings, office films and apparatus enclosures (computers, domestic appliances).

Preference is given to PVC rigid foam articles and PVC pipes for drinking water or wastewater, pressure pipes, gas pipes, cable-duct pipes and cable protection pipes, pipes for industrial pipelines, seepage pipes, flowoff pipes, guttering pipes and drainage pipes. For further details on this subject see “Kunststoffhandbuch PVC”, Vol. 2/2, W. Becker/H. Braun, 2nd ed., 1985, Carl Hanser Verlag, pages 1236-1277.

The following examples elucidate the intention, though without restricting it. As in the remainder of the description, parts and percentages are by weight.

The stabilizers 1-5, 7-9 and 11 summarized in table 1 were prepared by known methods, as described in Heterocycles, 53, 367 (2000); Synth., 1995, 1295; Chem. Ber. 90, 2272 (1957); J. Org. Chem. 16, 1879 (1951); J. Amer. Chem. Soc. 63, 2567 (1941); EP-A-0 001 735, or are available in chemicals trading.

The synthesis of the new compounds 6 and 10 is described below.

### EXAMPLE 1

### Compound 6

### Preparation of 1-(2-acetoxyethyl)-6-aminouracil

Starting material is literature-described 1-(2-hydroxyethyl)-6-aminouracil (substance A).

Added dropwise over the course of 60 minutes with stirring and cooling to a mixture of 17.1 g (0.1 mol) of A, 0.5 g of DMAP (dimethylaminopyridine), 12 g (0.12 mol) of Et₃N and 40 ml of DMA (dimethylacetamide) in a 250 ml three-necked flask is a solution of 12 g (0.12 mol) of Ac₂O in 10 ml of DMA at an internal temperature of approximately 20° C. The mixture is subsequently stirred at room temperature for an hour and admixed with 50 ml of MTBE (methyl tert-butyl ether). The deposited crystals (1.5 g) were identified as A and discarded. The filtrate is concentrated in vacuo and the deposited crystals (1.5 g) are again discarded. The filtrate is then concentrated under an oil-pump vacuum and the residue is recrystallized from 75 ml of a 3:1 mixture of n-propOH/H₂O.

This leads to the isolation of 10.3 g (corresponding to 48.3% of theory) of pale beige crystals of m.p. 225° C., whose ¹H NMR spectrum is compatible with the structure indicated.

### EXAMPLE 2

### Compound 10

### Preparation of 3-(2-hydroxy-n-butyl)-6-aminouracil

A mixture of 12.7 g (0.1 mol) of 6-aminouracil and 28.8 g (0.4 mol) of 1,2-butene oxide, 90 ml of water, and 10 ml of n-propanol is heated together with 0.4 g (0.1 mol) of caustic soda at 133° C. for 6.5 hours with stirring. Overnight, 2.5 g (22%) of starting uracil are deposited. The solid residue (10.7 g) which remains gave an indication in the ¹H NMR spectrum of about 80% of desired reaction product. By fractional crystallization from water the desired substance was obtained in an overall yield of 5.8 g (corresponding to 30% of theory, based on 6-aminouracil employed). The substance was characterized as the pure 3-substituted isomer. The melting point was 232° C.

TABLE 1
General formula:

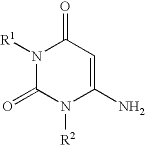

| Stabilizer | R² | R¹ | m.p. |
|---|---|---|---|
| 1 | H₃C— | H | 335-37° C. decomp. |
| 2 | HO—CH₂—CH₂— | H | 253-55° C. |
| 3 | H₃C—CH₂—CH₂— | H | 290-92° C. |
| 4 | H₃C—O—(CH₂)₃— | H | 202-204° C. |
| 5 | H₃C—(CH₂)₃— | H | 253-53° C. |
| 6 | H₃C—CO—O—CH₂—CH₂— | H | 224-26° C. |
| 7 | H₃C—(CH₂)₇— | H | 259-60° C. |
| 8 | H₃C—(CH₂)₁₁— | H | 239-40° C. |
| 9 | H | H₃C— | 343-44° C. decomp. |
| 10 | H | 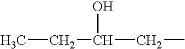 | 230-34° C. decomp. |
| 11 | H | H₃C—CH₂—CH₂— | 282-85° C. |
| 12 | H | H₃C(—CH₂)₃ | 290° C. |
| 13 | H | H₃C(CH₂)₇ | 270-71° C. |
| 14 | H | H₂C═CH—CH₂— | 264-65° C. |

### EXAMPLE 3

### Static Heat Test

A dry mixture consisting of

100.0 parts of Evipol (brand name of EVC) SH 5730 =PVC K value 57

5.0 parts of Paraloid (brand name of Rohm & Haas) BTA III N 2=MBS (methyl methacrylate-butadiene-styrene) modifier

0.5 part of Paraloid (brand name of Rohm & Haas) K 120 N=acrylate processing aid

0.5 part of Paraloid (brand name of Rohm & Haas) K 175=acrylate processing aid

1.0 part of Loxiol G 16=fatty acid partial ester of glycerol (from Henkel)

0.3 part of Wachs E=ester wax (montan wax) (from BASF)

3.0 parts of ESO=epoxidized soybean oil

0.1 part of magnesium laurate

0.03 part of CD 36-0020=30% strength solution of Na perchlorate monohydrate in butyl diglycol

and 0.6 part of the stabilizers indicated in table 1 were rolled on a set of mixing rolls at 180° C. for 5 minutes. Test film strips 0.3 mm thick were taken from the resultant rolled sheet. The film samples were subjected to a thermal load of 190° C. in an oven (Mathis Thermo-Takter). At intervals of 3 minutes the yellowness index (YI) was determined in accordance with ASTM D 1925-70.

The results are apparent from table 2. Low YI values denote effective stabilization.

TABLE 2

| Mins. | Stab.1 | Stab.2 | Stab.3 | Stab.4 | Stab.5 | Stab.11 | Stab.12 | Stab.13 | Stab.14 |
|---|---|---|---|---|---|---|---|---|---|
| 0 | 54.0 | 36.6 | 12.1 | 9.4 | 9.8 | 10.38 | 8.21 | 7.38 | 8.57 |
| 3 | 70.7 | 53.5 | 14.2 | 10.7 | 14.1 | 10.87 | 10.10 | 8.47 | 9.50 |
| 6 | 80.1 | 70.1 | 19.6 | 12.9 | 14.3 | 12.34 | 11.97 | 9.71 | 12.10 |
| 9 | 104.7 | 88.9 | 28.0 | 18.1 | 19.0 | 16.24 | 14.96 | 12.37 | 15.33 |
| 12 | | 106.2 | 36.2 | 25.2 | 25.5 | 20.40 | 18.79 | 15.60 | 19.60 |
| 15 | | | 46.9 | 35.1 | 34.2 | 23.83 | 23.46 | 20.53 | 25.55 |
| 18 | | | 58.1 | 47.2 | 44.1 | 27.98 | 29.08 | 26.99 | 33.00 |
| 21 | | | 69.6 | 63.1 | 55.5 | 33.61 | 36.98 | 33.89 | 43.12 |
| 24 | | | 80.4 | 85.1 | 71.1 | 41.66 | 47.02 | 42.85 | 55.52 |
| 27 | | | 90.8 | 117.0 | 87.0 | 51.38 | 62.66 | 51.26 | 73.00 |
| 30 | | | 103.4 | | 106.5 | 67.88 | 90.48 | 65.57 | 102.67 |
| 33 | | | | | | 105.10 | | 84.98 | |
| 36 | | | | | | | | 109.44 | |

It is apparent that the use of Stab. 3, 4 and 5 produces a good stabilizing action as compared with Stab. 1 and 2, and that Stab. 11-14 additionally have a better color retention (middle color). This effect was not foreseeable and therefore was surprising.

### EXAMPLE 4

### Static Heat Test

Analogous to example 1, but without the addition of magnesium laurate and CD 36-0020 (30% strength solution of Na perchlorate monohydrate in butyl diglycol).

The results are apparent from table 3.

TABLE 3

| Minutes | Stab.1 | Stab.2 | Stab.3 | Stab.4 | Stab.5 | Stab.6 | Stab.7 | Stab.9 | Stab.10 | Stab.11 | Stab.12 | Stab.13 | Stab.14 |
|---|---|---|---|---|---|---|---|---|---|---|---|---|---|
| 0 | 79.9 | 66.8 | 19.0 | 11.6 | 12.9 | 18.3 | 14.3 | 38.1 | 16.5 | 9.8 | 8.81 | 6.61 | 9.00 |
| 3 | 74.9 | 72.5 | 17.1 | 12.0 | 15.5 | 28.6 | 21.4 | 36.9 | 18.9 | 12.9 | 11.83 | 9.10 | 12.09 |
| 6 | 86.2 | 95.7 | 20.5 | 14.1 | 17.4 | 26.9 | 21.9 | 52.6 | 27.4 | 15.9 | 13.90 | 8.97 | 15.44 |
| 9 | 113.3 | 126.4 | 28.5 | 20.4 | 23.0 | 35.7 | 30.1 | 73.0 | 42.3 | 20.2 | 16.59 | 10.92 | 19.41 |
| 12 | | | 40.9 | 30.4 | 32.1 | 49.9 | 43.1 | 96.3 | 62.3 | 23.8 | 19.72 | 14.50 | 23.61 |
| 15 | | | 58.1 | 46.7 | 44.5 | 70.5 | 58.4 | 123.5 | 94.1 | 28.8 | 25.27 | 20.04 | 30.26 |
| 18 | | | 80.1 | 75.3 | 65.6 | 94.0 | 78.5 | | 127.8 | 34.6 | 31.27 | 28.92 | 38.58 |
| 21 | | | 105.6 | 136.7 | 95.2 | 125.3 | 107.7 | | | 43.7 | 40.69 | 42.40 | 57.00 |
| 24 | | | | | | | | | | 57.1 | 58.47 | 68.17 | 89.17 |
| 27 | | | | | | | | | | 82.2 | 110.67 | 113.16 | 182.84 |

It is apparent that the use of Stab. 3-7, 10 and 11 has a good stabilizing action as compared with Stab. 1, 2 and 9 and that the stabilizing action of Stab. 11-14 additionally shows a further superiority. This effect was not foreseeable and was therefore surprising.

1-26. (canceled)

27. A composition comprising a chlorinated polymer and at least one monosubstituted 6-aminouracil of the formula I 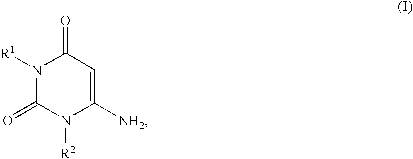
wherein
R¹ or R² is linear or branched C₃-C₂₂-alkyl, unsubstituted or C₁-C₄-alkyl/alkoxy- and/or hydroxyl-substituted phenyl, unsubstituted or C₁-C₄-alkyl/alkoxy- and/or hydroxyl-substituted phenyl C₁-C₄-alkyl, linear or branched C₃-C₁₈-alkenyl, C₃-C8-cycloalkyl, C₃-C₁₀-alkyl interrupted by at least 1 oxygen atom, or C₃-C₁₀-hydroxyalkyl or acetoxy/benzoyloxy-C₂-C₁₀-alkyl and R¹ or R² is hydrogen, and excluding R¹ and R² simultaneously C₂-C₄ alkyl.

28. The composition as claimed in claim 27, wherein R¹ or R² is phenyl, C₁-C₄-alkylphenyl, benzyl, 2-phenethyl, allyl or C₃-C₁₀-alkyl interrupted by oxygen atom, preferably as R¹ substituents.

29. The composition as claimed in claim 27, wherein R¹ or R² is C₃-C₁₂-alkyl, C₅-C₆-cycloalkyl or allyl, preferably as R¹ substituents.

30. The composition as claimed in claim 29, wherein R¹ or R² is C₃-C₈-alkyl, cycloalkyl or allyl, preferably as R¹ substituents.

31. The composition as claimed in claim 27, wherein R¹ or R² is phenyl, C₁-C₄-allylphenyl, benzyl, 2-phenethyl, allyl or C₃-C₁₀-alkyl interrupted by oxygen atom.

32. The composition as claimed in claim 27, wherein R¹ or R² is C₃-C]₂-alkyl, C₅-C₆-cycloalkyl or allyl.

33. The composition as claimed in claim 29, wherein R¹ or R² is C₃-C₈-alkyl, cyclohexyl or allyl.

34. The composition as claimed in claim 27, comprising a compound of the formula I and further at least one pyrrole compound or a disubstituted aminouracil analogous to the formula I with the same definitions for the radicals R¹ and R², with R¹ and R² in each case not being hydrogen.

35. The composition as claimed in claim 27, further comprising at least one epoxidized fatty acid ester.

36. The composition as claimed in claim 27, further comprising at least one zinc carboxylate or alkali metal carboxylate or alkaline earth metal carboxylate or aluminum carboxylate or combinations thereof.

37. The composition as claimed in claim 27, further comprising at least one substance selected from the group consisting of the phophites, antioxidants, beta-dicarbonyl compounds or their calcium, magnesium or zinc salt, plasticizers, fillers, lubricants or pigments or mixtures thereof.

38. The composition as claimed in claim 27, comprising chalk as filler.

39. The composition as claimed in claim 27, comprising calcium stearate or magnesium laurate and/or magnesium strearate as further additive.

40. The composition as claimed in claim 27, comprising titanium dioxide or zirconium dioxide or barium sulfate or combinations thereof as pigment.

41. The composition as claimed in claim 27, further comprising at least one polyol or a disaccharide alcohol or a trishydroxyalkyl isocyanurate ester or combinations thereof.

42. The composition as claimed in claim 27, further comprising at least one glycidal compound.

43. The composition as claimed in claim 27, further comprising at least one zeolite compound, in particular an Na-A or an Na—P zeolite of low particle size.

44. The composition as claimed in claim 27, further comprising at least one layered lattice compound (hydrotalcites).

45. The composition as claimed in claim 44, further comprising at least one perchlorate compound.

46. The composition as claimed in claim 43, further comprising at least one perchlorate compound.

47. The composition as claimed in claim 27, further comprising at least one perchlorate compound.

48. The composition as claimed in claim 27, comprising as chlorinated polymer a recyclate containing at least one percent by weight of recycled polymer.

49. A method of stabilizing a chlorinated polymer, comprising incorporating at least one compound of the formula I as claimed in claim 27 into the chlorinated polymer.

50. A method for stabilizing halogenated polymers, comprising using compounds of the general formula I as claimed in claim 27.

51. A method for stabilizing recycled halogenated polymers, comprising using compounds of the general formula I as claimed in claim 27.

52. Monosubstituted 6-aminouracils of the formula II 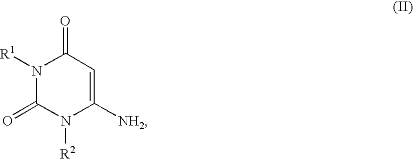
wherein
R¹ or R² is C₃-C₈-cycloalkyl, C₄-C₁₀-hydroxyalkyl or acetoxy/benzoyloxy-C₂-C₁₀-alkyl and R¹ or R² is hydrogen.

53. Compound as claimed in claim 52, wherein R¹ or R² is C₅- or C₆-cycloalkyl.
